(19) United States
(12) Patent Application Publication
(10) Pub. No.: US 2024/0408609 A1
(43) Pub. Date: Dec. 12, 2024

(54) Rotational Shredder

(71) Applicant: Brendan O'Dwyer, Thurles (IE)

(72) Inventor: Brendan O'Dwyer, Thurles (IE)

(21) Appl. No.: 18/700,639

(22) PCT Filed: Oct. 11, 2022
(86) PCT No.: PCT/IB2022/059758

§ 371 Date: Apr. 11, 2024

Related U.S. Application Data
(60) Provisional application No. 63/254,292, filed on Oct. 11, 2021.

(51) Int. Cl. B02C 18/14; B02C 18/00; B02C 18/24

(52) U.S. Cl. CPC B02C 18/14; B02C 18/0084; B02C 18/24; B02C 18/0007

(57) ABSTRACT

A rotational shredder apparatus suited for properly rendering sensitive material into un-recognizable and inert waste is presented. The rotational shredder apparatus consists of a twin chamber shredder with rotary mechanism, where the rotational shredder apparatus is configured to shred sensitive material into un-recognizable and inert waste. More specifically, unprocessed waste is inserted into one of the chambers. The unprocessed waste is then passed through the shredder. The rotary mechanism then flips the twin chamber shredder such that the shredded waste from the first chamber is then directed back into the shredder, where the second chamber receives the further shredded waste. This process is repeated until the sensitive material is rendered into un-recognizable and inert waste suitable for disposal.

### FIELD OF THE INVENTION

The present invention relates generally to office and industrial machinery. More specifically, the present invention is a device that allows for the complete shredding of various materials to take place, ensuring total destruction of the particular material.

### BACKGROUND OF THE INVENTION

Shredders are machines commonly used in offices and homes for a number of reasons. Most commonly, shredders are used for the disposal of important information as to prevent the important information from being stolen and used by others. For example, one may be in possession of a document containing sensitive material such as social security. Simply disposing of the document in one piece is dangerous as it could be stolen, and the information could be used by others. If one decides to rip the document by hand, the resulting pieces of the document could be large enough for the information on the document to be legible. This issue is usually approached with the use of a shredder. However, standard shredders can still leave legible wording on the document. Another potential use for shredders is when dealing with the disposal of biomass. Hospitals and morgues are consistently disposing of biomass and other potentially dangerous materials. These materials are in need of being disposed of carefully and safely. Shredders offer an ability of these materials to be split into smaller pieces of easier disposal. Standard shredders are single pass shredders, meaning the material is only shredded a single time. However, in both scenarios mentioned, additional passes through a shredder would aid in the necessary destruction of sensitive and potentially dangerous materials.

It is an objective of the present invention to provide one with solutions to the issues mentioned above through an apparatus capable of repeatedly shredding a variety of materials. The action of repeatedly shredding materials allows for the complete destruction of sensitive and potentially dangerous materials.

### SUMMARY OF THE INVENTION

The present invention is a device capable of repeatedly shredding a variety of materials via a rotational mechanism. The present invention is a rotational shredder that allows for sensitive and potentially dangerous materials to be broken down. Sensitive information on documents is then illegible and cannot be stolen and used by others, and potentially dangerous materials are broken down for easier disposal.

### BRIEF DESCRIPTION OF THE DRAWINGS

FIG. 1 is a perspective view of the present invention.

FIG. 2 is an exploded view of the present invention.

FIG. 3 is perspective view of the present invention that shows a rotary shredder.

FIG. 4 is a front side view of the present invention that shows the rotary shredder.

FIG. 5 is a right side view of the present invention that shows the rotary shredder.

FIG. 6 is an exploded view of the present invention that shows the rotary shredder.

FIG. 7 a system diagram of the present invention.

FIG. 8 is an electronics diagram of the present invention.

### DETAIL DESCRIPTIONS OF THE INVENTION

All illustrations of the drawings are for the purpose of describing selected versions of the present invention and are not intended to limit the scope of the present invention. The present invention is to be described in detail and is provided in a manner that establishes a thorough understanding of the present invention. There may be aspects of the present invention that may be practiced or utilized without the implementation of some features as they are described. It should be understood that some details have not been described in detail in order to not unnecessarily obscure focus of the invention. References herein to “the preferred embodiment”, “one embodiment”, “some embodiments”, or “alternative embodiments” should be considered to be illustrating aspects of the present invention that may potentially vary in some instances, and should not be considered to be limiting to the scope of the present invention as a whole.

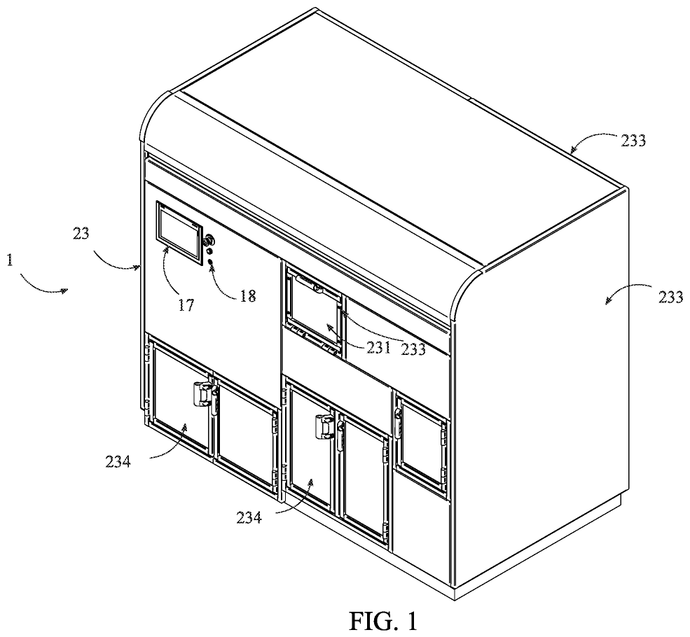

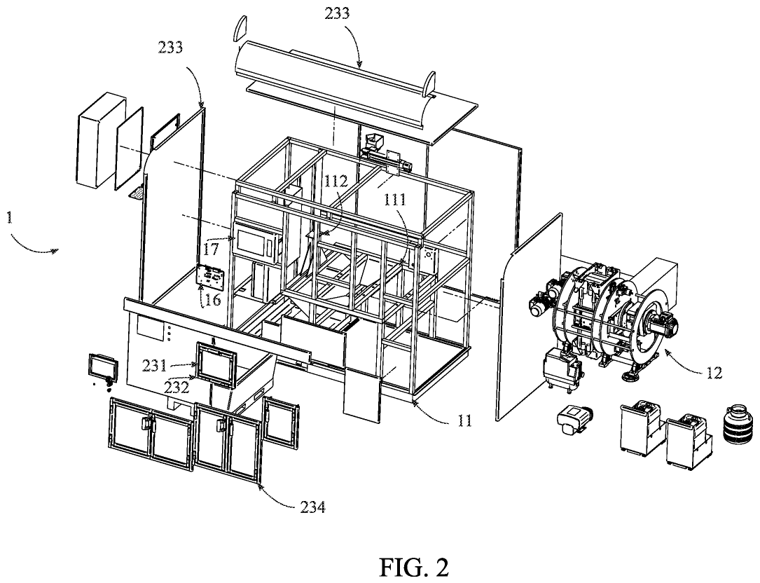

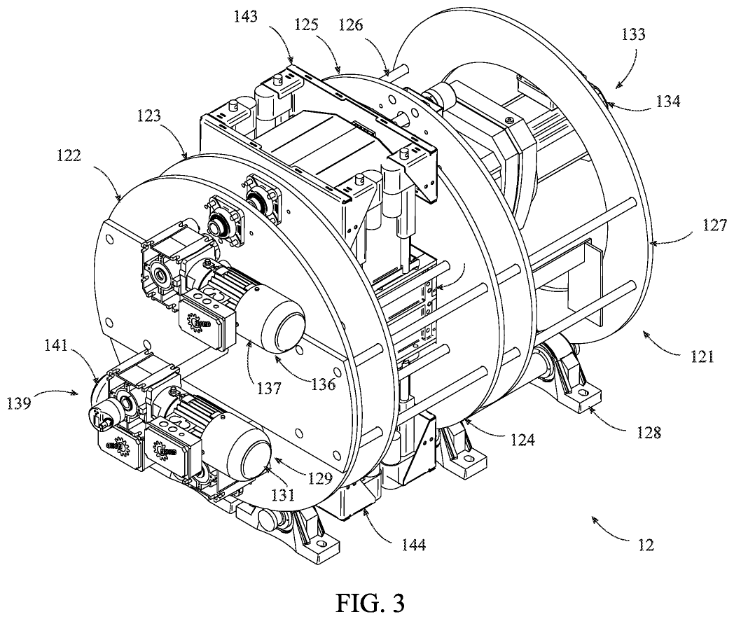

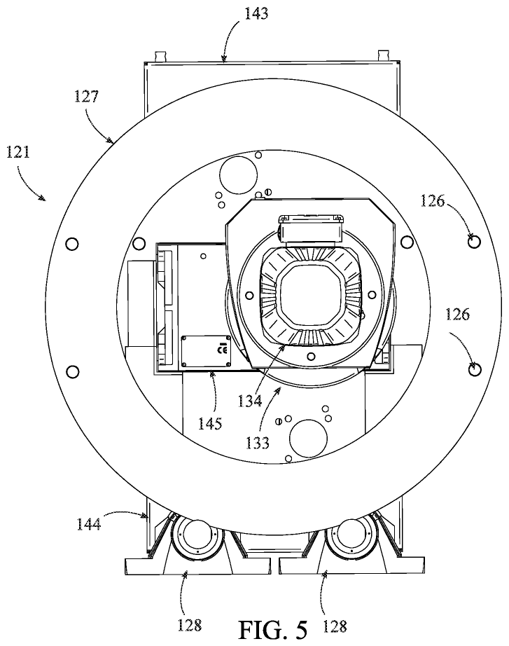

In reference to FIGS. 1-2, the present invention is a rotational shredder apparatus 1 suited for properly rendering sensitive material into un-recognizable and inert waste. In reference to FIGS. 1-2, the rotational shredder apparatus 1 comprises a shredder frame 11 and a rotary shredder 12. In reference to FIG. 2, the shredder frame 11 comprises a shredder platform 111 and a motor mount 112. In reference to FIGS. 3-6, the rotary shredder 12 comprises a rotary chassis 121, a plurality of rollers 128, a rotary motor 129, a shredder motor 133, a first chamber motor 136, a second chamber motor 139, a first chamber body 143, a second chamber body 144, and a shredding unit 145. In the preferred embodiment, the rotational shredder apparatus 1 is constructed out of durable materials suitable for handling heavy duty disposal tasks related in a variety of applications. In the preferred embodiment, the rotational shredder apparatus 1 is scaled to any suitable size in order to fit facilities, such as, but not limited to waste treatment plants, waste disposals in hospitals, or any other suitable facility. In the preferred embodiment, the shredder frame 11 takes the form of the main chassis of the rotational shredder apparatus 1 suitable for supporting and mounting the components the constitutes the rotational shredder apparatus 1. In the preferred embodiment, the shredder frame 11 is made out of any suitable building materials, such as, but not limited to stainless steel framing, aluminum extrusions, or any other suitable material. In the preferred embodiment, the rotary shredder 12 takes the form of a shredder module installed along the shredder frame 11. More specifically, the rotary shredder 12 is configured to render sensitive material into un-recognizable and inert waste. To do this, the rotary shredder 12 employs a twin-chamber multi-pass shredder mechanism, where the rotary shredder 12 is configured to accept sensitive material in the first chamber body 143, shred the sensitive material through the shredding unit 145, where the shredded material is then directed to the second chamber body 144. The process is then reverted, where the shredded material in the second chamber body 144 then directs the shredded material through the shredding unit 145, shreds the material a second time, and directs the shredded material through the first chamber body 143. This rotational shredding process is then repeated for multiple passes until the shredded material is turned into processed waste, where the processed waste takes the form of un-recognizable and inert waste suitable for conventional disposal. The processed waste in the second chamber body 144 can then be directed to any suitable waste treatment or waste storage system for proper disposal.

The shredder platform 111 takes the form of any suitable mounting platform that supports and mounts the rotary shredder 12 to the shredder frame 11. In the preferred embodiment, the motor mount 112 takes the form of any suitable mounting bracket that mounts the rotary motor 129 to the shredder frame 11 and orients the rotary motor 129 to the installed rotary shredder 12 along the shredder platform 111. In the preferred embodiment, the rotary chassis 121 takes the form of main rotary body of the rotary shredder 12 that supports and constitutes the components the constitutes the rotary shredder 12. In the preferred embodiment, the plurality of rollers 128 takes the form of any suitable rotary roller mounting element that rotatably engages along the rotary chassis 121 such that the rotary chassis 121 rotates freely along the shredder frame 11. In the preferred embodiment, the rotary motor 129 takes the form of any suitable motor driving element, where the rotary motor 129 is configured to drive the rotary chassis 121 along the rotary frame. In the preferred embodiment, the shredder motor 133 takes the form of any suitable motor driving element, where the shredder motor 133 is configured to drive the shredding unit 145. In the preferred embodiment, the first chamber motor 136 takes the form of an actuating motor driver, where the first chamber motor 136 is configured to swing the first chamber body 143 to an open configuration or a close configuration along the rotary chassis 121. In the preferred embodiment, the open configuration of the first chamber body 143 allows access to the first chamber body 143, where a user can then insert unprocessed waste within the first chamber body 143. The close configuration of the first chamber body 143 is configured to direct the first chamber body 143 along the shredding unit 145, such that the unprocessed waste stored within the first chamber body 143 is in fluid communication with the shredding unit 145. In the preferred embodiment, the second chamber motor 139 takes the form of an actuating motor driver, where the second chamber motor 139 is configured to swing the second chamber body 144 to an open configuration or a close configuration along the rotary chassis 121. In the preferred embodiment, the open configuration of the second chamber body 144 is configured to allow the processed waste stored in the second chamber to be in fluid communication with any suitable waste disposal system. The close configuration of the second chamber body 144 is configured to allow the shredded waste to be in fluid communication with the shredding unit 145. In the preferred embodiment, the first chamber body 143 takes the form of any suitable chamber vessel that is configured to serve as the initial chamber vessel that the unprocessed waste is inserted in. In the preferred embodiment, the second chamber body 144 takes the form of any suitable chamber vessel that is configured to serve at the final chamber vessel that the processed waste is then directed and deposited into any suitable waste treatment system. In the preferred embodiment, the shredding unit 145 takes the form of any suitable dual feeding shredding unit 145 suitable for rendering unprocessed sensitive material into processed waste suitable for waste disposal.

The shredder platform 111 is connected within the shredder frame 11, where the shredder platform 111 is configured to securely mount the rotary shredder 12 within the shredder frame 11. The motor mount 112 is connected within the shredder frame 11, where the motor mount 112 is configured to securely mount the rotary motor 129 to the shredder frame 11 and orient the rotary motor 129 to the rotary chassis 121. The rotary shredder 12 is connected along the shredder platform 111. The plurality of rollers 128 is distributed about the shredder platform 111. The rotary chassis 121 is rotatably connected along the plurality of rollers 128. The rotary motor 129 is connected adjacent to the motor mount 112. The rotary motor 129 is torsionally engaged to the rotary chassis 121. The shredding unit 145 is connected within the rotary chassis 121. The first chamber body 143 is hingedly connected adjacent to the shredding unit 145. The second chamber body 144 is hingedly connected adjacent to the shredding unit 145, opposite to the first chamber body 143. The shredding unit 145 is in fluid communication with the first chamber body 143 and the second chamber body 144. The shredder motor 133 is connected within the rotary chassis 121. The shredder motor 133 is operatively engaged to the shredding unit 145. The first chamber motor 136 is connected within the rotary chassis 121. The first chamber motor 136 is operatively engaged to the first chamber body 143, where the first chamber motor 136 is configured to swivel the first chamber body 143 to an open or close configuration along the shredder chassis. The second chamber motor 139 is connected within the rotary chassis 121. The second chamber motor 139 is operatively engaged to the first chamber body 143, where the second chamber motor 139 is configured to swivel the first chamber body 143 to an open or close configuration along the shredder chassis.

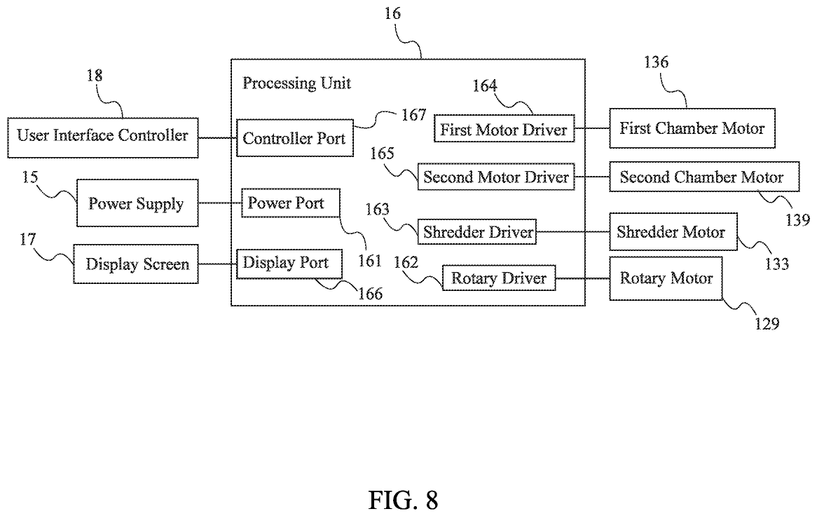

In reference to FIG. 8, the rotary shredder 12 apparatus further comprises a power supply 15 and a processing unit 16. In reference to FIG. 8, the processing unit 16 comprises a power port 161, a rotary driver 162, a shredder driver 163, a first motor driver 164, and a second motor driver 165. In the preferred embodiment, the power supply 15 takes the form of any suitable power supply 15 suitable for powering the electrical components that constitutes the rotary shredder 12 apparatus such as, but not limited to AC power adapters, batteries, or any other suitable power supply 15. In the preferred embodiment, the processing unit 16 takes the form of any suitable electronics processing board suitable for supporting, regulating, or processing electrical or electronic elements that constitutes the rotary shredder 12 apparatus. The power port 161, the rotary driver 162, the shredder driver 163, the first motor driver 164, and the second motor driver 165 are electronically connected to the processing unit 16. The power supply 15 is electronically connected to the power port 161. The rotary motor 129 is electronically connected to the rotary driver 162. The shredder motor 133 is electronically connected to the shredder driver 163. The first chamber motor 136 is electronically connected to the first motor driver 164. The second chamber motor 139 is electronically connected to the second motor driver 165.

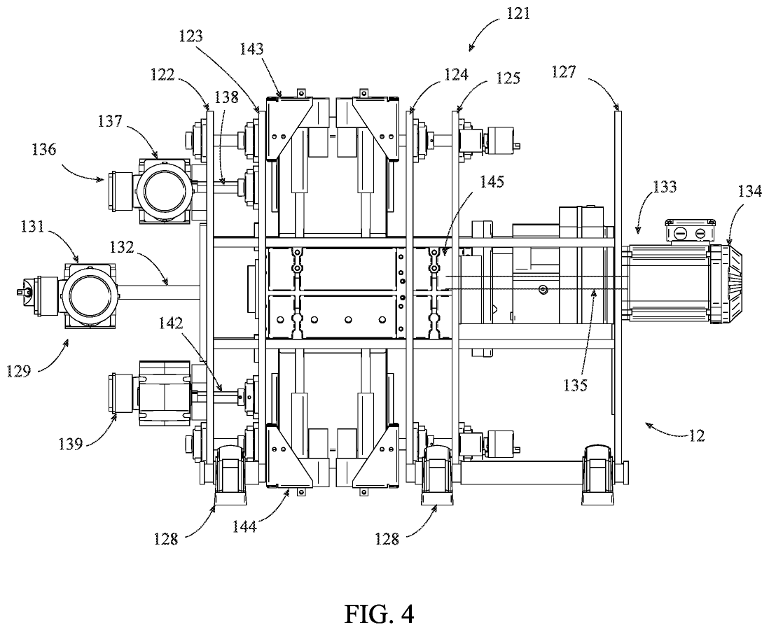

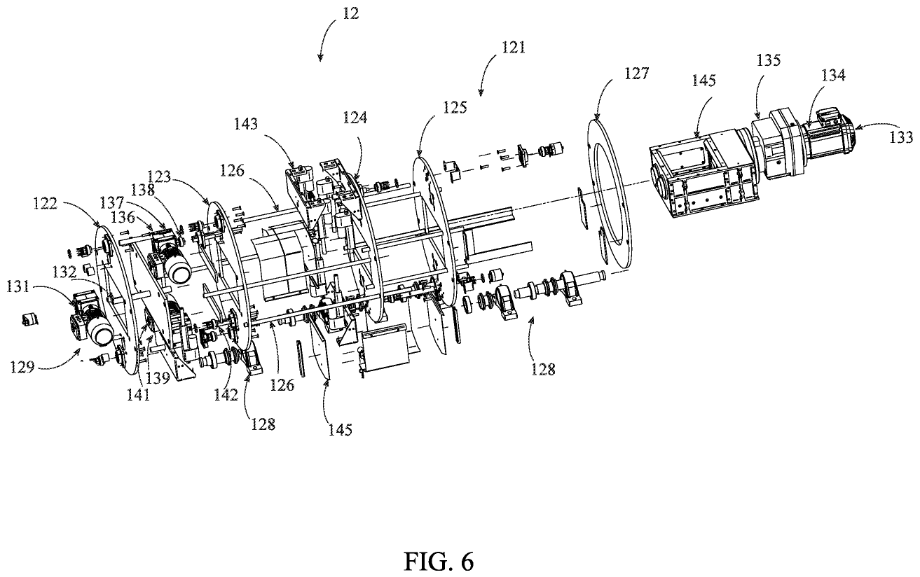

In reference to FIGS. 4 and 6, the rotary motor 129 comprises a rotary stator 131 and a rotary rotor 132. The rotary stator 131 is connected adjacent to the motor mount 112. The rotary rotor 132 is torsionally engaged to the rotary stator 131. In the preferred embodiment, the rotary stator 131 takes the form of the motor body of the rotary motor 129 that is configured to mount along the motor mount 112. In the preferred embodiment, the rotary rotor 132 takes the form of the torsional element of the rotary stator 131 that torsionally engages and drives the rotary chassis 121. In reference to FIGS. 4 and 6, the rotary chassis 121 comprises a mounting plate 122. The mounting plate 122 takes the form of a rotary plate that mounts the rotary motor 129, the first chamber motor 136, and the second chamber motor 139 along the rotary chassis 121. The mounting plate 122 is torsionally connected to the rotary rotor 132, where the mounting plate 122 is configured to act as a direct drive spindle for the rotary chassis 121. The mounting plate 122 is rotatably engaged to the plurality of rollers 128. In reference to FIGS. 4 and 6, the rotary chassis 121 further comprises a first receiver plate 123, a second receiver plate 124, and a plurality of support rods 126. The first receiver plate 123 and the second receiver plate 124 takes the form of a set of rotary plates suitable for receiving and mounting the shredding unit 145 along the rotary chassis 121. Additionally, the first receiver plate 123 and the second receiver plate 124 are configured to mount and align the first chamber body 143 and the second chamber body 144 along the shredding unit 145. The first receiver plate 123 is positioned adjacent to the mounting plate 122. The shredding unit 145 is centrally connected to the first receiver plate 123. The second receiver plate 124 is centrally connected to the shredding unit 145, opposite to the mounting plate 122. The first chamber body 143 and the second chamber body 144 are hingedly connected between the first receiver plate 123 and the second receiver plate 124. The first receiver plate 123 and the second receiver plate 124 is rotatably engaged to the plurality of rollers 128. The mounting plate 122, the first receiver plate 123, and the second receiver plate 124 is connected together through the plurality of support rods 126. In reference to FIGS. 4 and 6, the rotary chassis 121 further comprises a third receiver plate 125. In the preferred embodiment, the third receiver plate 125 takes the form of a rotary plate suitable for receiving and mounting the shredding unit 145 along the rotary chassis 121. The third receiver plate 125 is centrally connected to the shredding unit 145, opposite to the first receiver plate 123. The third receiver plate 125 is rotatably engaged to the plurality of rollers 128. The third receiver plate 125 is torsionally connected to the second receiver plate 124 through the plurality of support rods 126.

In reference to FIGS. 4 and 6, the first chamber motor 136 comprises a first chamber stator 137 and a first chamber rotor 138. In the preferred embodiment, the first chamber stator 137 takes the form of the motor body of the first chamber motor 136 mount 112ed along the mounting plate 122. The first chamber rotor 138 takes the form of the rotary driver 162 of the first chamber motor 136 that torsionally engages to the first chamber body 143. The first chamber stator 137 is connected adjacent to the mounting plate 122. The first chamber rotor 138 is torsionally engaged to the first chamber stator 137. The first chamber rotor 138 is torsionally connected to the first chamber body 143, where the first chamber rotor 138 is configured to swivel the first chamber body 143 to an open or close configuration along the shredder chassis. In reference to FIGS. 4 and 6, the second chamber motor 139 comprises a second chamber stator 141 and a second chamber rotor 142. In the preferred embodiment, the first chamber stator 137 takes the form of the motor body of the second chamber motor 139 mount 112ed along the mounting plate 122. The second chamber rotor 142 takes the form of the rotary driver 162 of the second chamber motor 139 that torsionally engages to the second chamber body 144. The second chamber stator 141 is connected adjacent to the mounting plate 122. The second chamber rotor 142 is torsionally engaged to the second chamber stator 141. The second chamber rotor 142 is torsionally connected to the second chamber body 144, where the second chamber rotor 142 is configured to swivel the second chamber body 144 to an open or close configuration along the shredder chassis.

In reference to FIGS. 4-6, the shredder motor 133 comprises a shredder stator 134 and a shredder rotor 135. In the preferred embodiment, the shredder stator 134 takes the form of the motor body of the shredder motor 133 that mounts directly to the shredding unit 145. The shredder rotor 135 takes the form of the rotary driver 162 of the shredder motor 133 that torsionally drives and engages to the shredding unit 145. The shredder stator 134 is connected adjacent to the shredding unit 145. The shredder rotor 135 is torsionally engaged to the shredding unit 145.

In reference to FIGS. 4-6, the rotary chassis 121 further comprises a rotary support plate 127. The rotary support plate 127 takes the form of a rotary plate that provides further structural support for the rotary chassis 121. The rotary support plate 127 is terminally connected opposite from the mounting plate 122 through the plurality of support rods 126. The rotary support plate 127 is rotatably engaged to the plurality of rollers 128.

In reference to FIGS. 1-2 and 8, the rotational shredder apparatus 1 further comprises a display screen 17. In reference to FIG. 8, the processing unit 16 further comprises a display port 166. In the preferred embodiment, the display screen 17 serves as an electrical visual projection element that displays interface data relevant to the rotational shredder apparatus 1. The display port 166 is electronically connected to the processing unit 16. The display screen 17 is connected adjacent to the shredder frame 11. The display screen 17 is electronically connected to the display port 166.

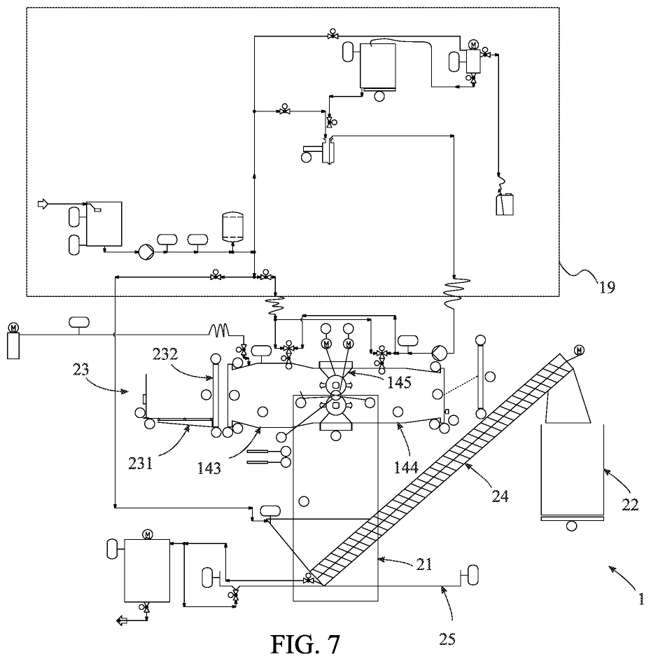

In reference to FIGS. 1 and 8, the rotational shredder apparatus 1 further comprises a user interface controller 18. In reference to FIG. 8, the processing unit 16 further comprises a controller port 167. In the preferred embodiment, the user interface controller 18 takes the form of any suitable controlling module that allows the user to operate and control the rotational shredder apparatus 1. The controller port 167 is electronically connected to the processing unit 16. The user interface controller 18 is electronically connected to the controller port 167. In reference to FIG. 7, the rotational shredder apparatus 1 further comprises a fluid dispensing mechanism 19. The fluid dispensing mechanism 19 takes the form of any suitable fluid dispensing mechanism 19 suitable for dispensing an acid water solution along the first chamber body 143 in order to turn the inserted unprocessed waste into a slurry suitable for shredding. The fluid dispensing mechanism 19 is connected within the shredder frame 11. The fluid dispensing mechanism 19 is in fluid communication with the first chamber body 143. In reference to FIG. 7, the rotational shredder apparatus 1 further comprises a waste storage vessel 21. In the preferred embodiment, the waste storage takes the form of any suitable storage vessel that receives processed waste from the second chamber body 144. The waste storage vessel 21 is connected within the shredder frame 11. The waste storage vessel 21 is in fluid communication with the second chamber body 144, where the waste storage vessel 21 is configured to be in fluid communication with the second chamber body 144 in the open configuration of the second chamber body 144.

In the preferred embodiment, the rotational shredder apparatus 1 a solid liquid separator 24. In the preferred embodiment, the solid liquid separate takes the form of any suitable system that can separate solid waste from liquid waste for proper disposal. In one embodiment, the solid liquid separator 24 takes the form of a perforated conveyor system, where liquid waste is permeated through the perforated conveyor system while the solid waste is directed to a solid waste vessel 22. The solid liquid separator 24 is connected within the shredder frame 11. The solid liquid separator 24 is in fluid communication with the waste storage vessel 21. In reference to FIG. 7, the rotational shredder apparatus 1 further comprises a drainage system 25. The drainage system 25 takes the form of any suitable drainage implement that intercept and receive the liquid waste segregated from the solid liquid separator 24 such that the drainage system 25 then directs the liquid waste into a liquid waste vessel or directly to a liquid waste treatment system. The drainage system 25 is connected within the shredder frame 11. The drainage system 25 is in fluid communication with the solid liquid separator 24. In reference to FIG. 7, the rotational shredder apparatus 1 further comprises the solid waste vessel 22. The solid waste vessel 22 is connected within the shredder frame 11. The solid waste vessel 22 is connected adjacent to the solid liquid separator 24.

In reference to FIGS. 1-2, the rotational shredder apparatus 1 further comprises a shredder enclosure 23. In the preferred embodiment, the shredder enclosure 23 takes the form of a protective cover that protects the frame and prevents waste from leaking out of the rotational shredder apparatus 1, providing a sterile system. In reference to FIGS. 1-2, the shredder enclosure 23 comprises a depositing door 231 and a depositing window 232. In the preferred embodiment, the depositing window 232 serves as the access opening of the shredder enclosure 23, specifically serving as depositing port for the user to insert unprocessed waste for shredding into the first chamber body 143. The depositing door 231 serves as a covering element for the depositing window 232, fully enclosing the shredder enclosure 23 when the rotational shredder apparatus 1 in in user. The shredder frame 11 is connected within the shredder enclosure 23. The depositing window 232 traversing through the shredder enclosure 23. The depositing window 232 is positioned adjacent to the first chamber body 143, where the depositing window 232 is configured to expose the first chamber body 143 in an open configuration. The depositing door 231 is hingedly connected to the depositing window 232. In reference to FIGS. 1-2, the shredder enclosure 23 further comprises a plurality of panels 233. In the preferred embodiment, the plurality of panels 233 takes the form of multiple enclosure panel implements that allows for easy replacement or disassembly for the shredder enclosure 23 for access or servicing. The plurality of panels 233 is distributed about the shredder frame 11. In reference to FIGS. 1-2, the shredder enclosure 23 further comprises a plurality of access hatches 234. In the preferred embodiment, the plurality of access hatches 234 serves as access implements that provides assess to the components that constitutes the rotational shredder apparatus 1 for servicing. The plurality of access hatches 234 is distributed about the shredder enclosure 23.

Although the invention has been explained in relation to its preferred embodiment, it is to be understood that many other possible modifications and variations can be made without departing from the spirit and scope of the invention as hereinafter claimed.

What is claimed is:

1. A rotational shredder apparatus comprising:
a shredder frame;
a rotary shredder;
the shredder frame comprising a shredder platform and a motor mount;
the rotary shredder comprising a rotary chassis, a plurality of rollers, a rotary motor, a shredder motor, a first chamber motor, a second chamber motor, a first chamber body, a second chamber body, and a shredding unit;
the shredder platform being connected within the shredder frame;
the motor mount being connected within the shredder frame;
the rotary shredder being connected along the shredder platform;
the plurality of rollers being distributed about the shredder platform;
the rotary chassis being rotatably connected along the plurality of rollers;
the rotary motor being connected adjacent to the motor mount;
the rotary motor being torsionally engaged to the rotary chassis;
the shredding unit being connected within the rotary chassis;
the first chamber body being hingedly connected adjacent to the shredding unit;
the second chamber body being hingedly connected adjacent to the shredding unit, opposite to the first chamber body;
the shredding unit being in fluid communication with the first chamber body and the second chamber body;
the shredder motor being connected within the rotary chassis;
the shredder motor being operatively engaged to the shredding unit;
the first chamber motor being connected within the rotary chassis;
the first chamber motor being operatively engaged to the first chamber body, wherein the first chamber motor is configured to swivel the first chamber body to an opened or closed configuration along the shredder chassis;
the second chamber motor being connected within the rotary chassis; and
the second chamber motor being operatively engaged to the first chamber body, wherein the second chamber motor is configured to swivel the first chamber body to an opened or closed configuration along the shredder chassis.

2. The rotational shredder apparatus as claimed in claim 1 comprising:
a power supply;
a processing unit;
the processing unit comprising a power port, a rotary driver, a shredder driver, a first motor driver, and a second motor driver;
the power port, the rotary driver, the shredder driver, the first motor driver, and the second motor driver being electronically connected to the processing unit;
the power supply being electronically connected to the power port;
the rotary motor being electronically connected to the rotary driver;
the shredder motor being electronically connected to the shredder driver;
the first chamber motor being electronically connected to the first motor driver; and
the second chamber motor being electronically connected to the second motor driver.

3. The rotational shredder apparatus as claimed in claim 1 comprising:
the rotary motor comprising a rotary stator and a rotary rotor;
the rotary stator being connected adjacent to the motor mount; and
the rotary rotor being torsionally engaged to the rotary stator.

4. The rotational shredder apparatus as claimed in claim 3 comprising:
the rotary chassis comprising a mounting plate;
the mounting plate being torsionally connected to the rotary rotor;
the mounting plate being rotatably engaged to the plurality of rollers.

5. The rotational shredder apparatus as claimed in claim 4 comprising:
the rotary chassis further comprising a first receiver plate, a second receiver plate, and a plurality of support rods;
the first receiver plate being positioned adjacent to the mounting plate;
the shredding unit being centrally connected to the first receiver plate;
the second receiver plate being centrally connected to the shredding unit, opposite to the mounting plate;
the first chamber body and the second chamber body being hingedly connected between the first receiver plate and the second receiver plate;
the first receiver plate and the second receiver plate being rotatably engaged to the plurality of rollers; and
the mounting plate, the first receiver plate, and the second receiver plate being connected together through the plurality of support rods.

6. The rotational shredder apparatus as claimed in claim 5 comprising:
the rotary chassis further comprises a third receiver plate;
the third receiver plate being centrally connected to the shredding unit, opposite to the first receiver plate; and
the third receiver plate being rotatably engaged to the plurality of rollers; and
the third receiver plate being torsionally connected to the second receiver plate through the plurality of support rods.

7. The rotational shredder apparatus as claimed in claim 4 comprising:
the first chamber motor comprising a first chamber stator and a first chamber rotor;
the first chamber stator being connected adjacent to the mounting plate;
the first chamber rotor being torsionally engaged to the first chamber stator; and
the first chamber rotor being torsionally connected to the first chamber body, wherein the first chamber rotor is configured to swivel the first chamber body to an opened or closed configuration along the shredder chassis.

8. The rotational shredder apparatus as claimed in claim 4 comprising:
the second chamber motor comprising a second chamber stator and a second chamber rotor;
the second chamber stator being connected adjacent to the mounting plate;
the second chamber rotor being torsionally engaged to the second chamber stator; and
the second chamber rotor being torsionally connected to the second chamber body, wherein the second chamber rotor is configured to swivel the second chamber body to an open or closed configuration along the shredder chassis.

9. The rotational shredder apparatus as claimed in claim 1 comprising:
the shredder motor comprising a shredder stator and a shredder rotor;
the shredder stator being connected adjacent to the shredding unit; and
the shredder rotor being torsionally engaged to the shredding unit.

10. The rotational shredder apparatus as claimed in claim 4 comprising:
the rotary chassis further comprises a rotary support plate;
the rotary support plate being terminally connected opposite from the mounting plate through the plurality of support rods; and
the rotary support plate being rotatably engaged to the plurality of rollers.

11. The rotational shredder apparatus as claimed in claim 2 comprising:
the processing unit further comprising a display port;
a display screen;
the display port being electronically connected to the processing unit;
the display screen being connected adjacent to the shredder frame; and
the display screen being electronically connected to the display port.

12. The rotational shredder apparatus as claimed in claim 2 comprising:
a user interface controller;
the processing unit further comprising a controller port;
the controller port being electronically connected to the processing unit; and
the user interface controller being electronically connected to the controller port.

13. The rotational shredder apparatus as claimed in claim 1 comprising:
a fluid dispensing mechanism;
the fluid dispensing mechanism being connected within the shredder frame; and
the fluid dispensing mechanism being in fluid communication with the first chamber body.

14. The rotational shredder apparatus as claimed in claim 1 comprising:
a waste storage vessel;
the waste storage vessel being connected within the shredder frame; and
the waste storage vessel being in fluid communication with the second chamber body, wherein the waste storage vessel is configured to be in fluid communication with the second chamber body in the open configuration of the second chamber body.

15. The rotational shredder apparatus as claimed in claim 14 comprising:
a solid liquid separator;
the solid liquid separator being connected within the shredder frame; and
the solid liquid separator being in fluid communication with the waste storage vessel.

16. The rotational shredder apparatus as claimed in claim 15 comprising:
a drainage system;
the drainage system being connected within the shredder frame; and
the drainage system being in fluid communication with the solid liquid separator.

17. The rotational shredder apparatus as claimed in claim 15 comprising:
a solid waste vessel;
the solid waste vessel being connected within the shredder frame; and
the solid waste vessel being connected adjacent to the solid liquid separator.

18. The rotational shredder apparatus as claimed in claim 1 comprising:
a shredder enclosure;
the shredder enclosure comprising a depositing door and a depositing window,
the shredder frame being connected within the shredder enclosure;
the depositing window traversing through the shredder enclosure;
the depositing window being positioned adjacent to the first chamber body, wherein the depositing window is configured to expose the first chamber body in an open configuration; and
the depositing door being hingedly connected to the depositing window.

19. The rotational shredder apparatus as claimed in claim 18 comprising:
the shredder enclosure further comprising a plurality of panels; and
the plurality of panels being distributed about the shredder frame.

20. The rotational shredder apparatus as claimed in claim 18 comprising:
the shredder enclosure further comprising a plurality of access hatches; and
the plurality of access hatches being distributed about the shredder enclosure.
